(19) United States
(12) Patent Application Publication
(10) Pub. No.: US 2025/0326515 A1
(43) Pub. Date: Oct. 23, 2025

(54) LABELING MACHINE AND METHOD FOR APPLYING LABELS TO CONTAINERS

(71) Applicant: Acmi Labelling S.R.L., Sorbolo (Parma) (IT)

(72) Inventors: Maurizio PEDERCINI, Marmirolo (IT); Paolo LANFREDI SOFIA, Castellucchio (IT); Alessandro GAZZINI, San Benedetto PO (IT)

(21) Appl. No.: 18/870,874

(22) PCT Filed: May 30, 2023
(86) PCT No.: PCT/IB2023/055517

§ 371 Date: Dec. 2, 2024

(30) Foreign Application Priority Data
Jun. 3, 2022 (IT) 102022000011729

(51) Int. Cl. B65C 9/18; B65C 9/40

(52) U.S. Cl. CPC B65C 9/1819; B65C 9/40; B65C 2009/404

(57) ABSTRACT

A machine for labeling containers including an assembly for feeding containers to be labeled to a labeling assembly, the labeling assembly has an assembly for unwinding a labeling ribbon which includes, along its extension, labels, a cutting device arranged downstream of the unwinding assembly and configured to cut the labeling ribbon at respective separation portions so as to obtain the labels, downstream of the cutting device there being transfer elements adapted to move the respective labels separated after cutting into contact with corresponding containers at a transfer region, and a removal component, which can be activated on command, for removing at least one label from the flow of labels and are arranged upstream of the transfer region.

### CROSS-REFERENCE TO RELATED APPLICATIONS

This application is a 35 U.S.C. § 371 National Stage patent application of PCT/IB2023/055517, filed on 30 May 2023, which claims the benefit of Italian patent application 102022000011729, filed on 3 Jun. 2022, the disclosures of which are incorporated herein by reference in their entirety.

### TECHNICAL FIELD

The present disclosure relates to a labeling machine and to a method for applying labels to containers.

### BACKGROUND

Labeling machines are known which are shaped to apply labels on containers.

Typically, known labeling machines have a feeder or conveyor of the containers to be labeled which comprises rotating support plates, which are configured to rotate the containers about their own axis.

Moreover, known labeling machines have a so-called labeling assembly constituted by a device for feeding a continuous ribbon of labels, a device for cutting said continuous ribbon in order to obtain respective labels, a device for applying an adhesive to each cut label, and a device for applying the label with adhesive to a container carried by the respective plate.

Typically, the feeding device comprises an unwinding assembly which is constituted by an unwinding roller and a traction roller and is configured to transfer the ribbon of labels from a spool toward a cutting drum, which is associated with at least one cutting element for separating the respective labels.

A so-called transfer drum is arranged downstream of the cutting drum along the label advancement direction.

The transfer drum is normally divided into circular sectors, each of which is designed to receive a respective label from the cutting drum.

At the longitudinal ends of the sectors of the transfer drum there are protrusions, also known as sliders, which are arranged in relief and to which the longitudinal ends of the cut labels face so that such ends can be contacted by an adhesive roller or by devices for applying adhesive.

In order to allow a precise application of the adhesive and a correct positioning of the label, the transfer drum has a lateral surface provided with a plurality of holes connected to means for forced air extraction, so that the labels are kept in adhesion against the lateral surface of the transfer drum.

In practice, during the operation of the labeling machine the unwinding roller supplies the cutting roller with the continuous ribbon of labels, the cutting roller cuts the ribbon so as to gradually make the labels available which, by means of the transfer drum, are applied to the containers to be labeled.

One particularly felt problem of the labeling machines described above relates to the need to “discard” labels that are not to be transferred to the containers.

One solution to this technical problem is described in EP2832652 in the name of Sidel, which describes a suction-equipped transfer drum configured to move and transfer labels along a path which extends around the axis of the drum for applying labels to respective containers.

In particular, the transfer drum is of the type adapted to receive a succession of labels at an intake station in order to transfer them to an application station located at a given first angular distance from the intake station.

During use, the ribbon of labeling material is made to advance between a fixed blade and a rotating blade of the cutting unit, and the leading edge of the cut label is picked up by suction from the transfer drum.

By conveniently setting the advancement speed of the ribbon of labeling material toward the transfer drum and the rotation rate of the cutting drum, it is possible to adjust the length of the labels.

In EP2832652, the picked-up labels can be held selectively against the outer lateral surface of the transfer drum substantially for a second angular distance which is greater than the first angular distance, and delivered to a discarding station arranged downstream with respect to a label advancement direction along the path of the label.

The known solution described above, while allowing to discard labels not transferred to the containers, has some drawbacks.

The main drawback is determined by the fact that rejection occurs after the label has passed beyond the adhesive application region.

Therefore, the adhesive has already been applied to the labels to be discarded, leading to some difficulties in managing the discarding operation (the label with adhesive applied may stick to parts of the machine), as well as in managing the discarded label.

### SUMMARY

The aim of the present disclosure is to provide a labeling machine and a method for applying labels to containers that are capable of improving the background art in one or more of the above-mentioned aspects.

Within this aim, the disclosure provides a labeling machine and a method for applying labels to containers that allow to avoid adhesive being applied to the labels to be discarded.

Not least does the disclosure provide a labeling machine and a method for applying labels to containers that are highly reliable, relatively easy to provide and at competitive costs.

This aim and these and other advantages that will become better apparent hereinafter are achieved by a labeling machine and by a method for applying labels to containers according to the independent claims, optionally provided with one or more of the characteristics of the dependent claims.

### BRIEF DESCRIPTION OF THE DRAWINGS

Further characteristics and advantages of the disclosure will become better apparent from the description of a preferred but not exclusive embodiment of the labeling machine and of the method for applying labels to containers according to the disclosure, illustrated by way of non-limiting example in the accompanying drawings, wherein:

FIG. 1 is a top view of a portion of a labeling machine according to the disclosure; and

FIG. 2 is a perspective view of a portion of the labeling machine of FIG. 1.

### DETAILED DESCRIPTION OF THE DRAWINGS

With reference to the figures, the labeling machine according to the disclosure, generally designated by the reference numeral 1, comprises an assembly 10a for feeding containers 10 to be labeled to a labeling assembly 2.

By way of example, the feeding assembly 10a comprises, at its peripheral region, supporting plates 11 to which the containers 10 to be labeled are fed by means of, for example, a feeding star conveyor.

The labeling assembly 2 comprises an assembly for unwinding a labeling ribbon 21.

The labeling ribbon 21 comprises, along its extension, a plurality of labels 22.

The labeling assembly 2 comprises furthermore a cutting device, which is arranged downstream of the unwinding assembly and is configured to cut the labeling ribbon 21 at respective separation portions, so as to obtain the labels 22.

Downstream of the cutting device there are transfer means, which are adapted to move the respective labels 22, separated after cutting, into contact with corresponding containers 10.

The transfer means face an adhesive application device 5, which is configured to apply to at least one portion 22a of the labels 22 at least one adhesive prior to their transfer to the corresponding container 10.

The adhesive application device 5 comprises, for example, an adhesive roller; nothing forbids, however, to apply the adhesive with spreading devices or with non-contact devices, for example sprays or atomizers.

According to the present disclosure, the labeling machine 1 comprises removal means 13, which can be activated on command, for removing at least one label 22b from the flow of labels 22; the removal means 13 are, in particular, arranged upstream of the transfer region 50.

Preferably, the removal means 13 are arranged upstream of the adhesive application device 5.

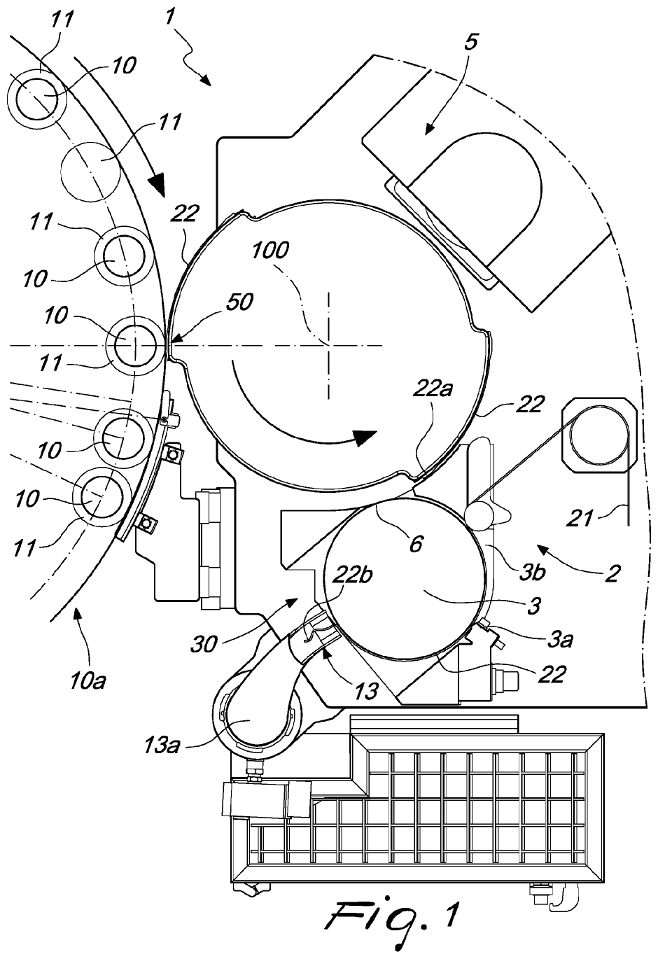

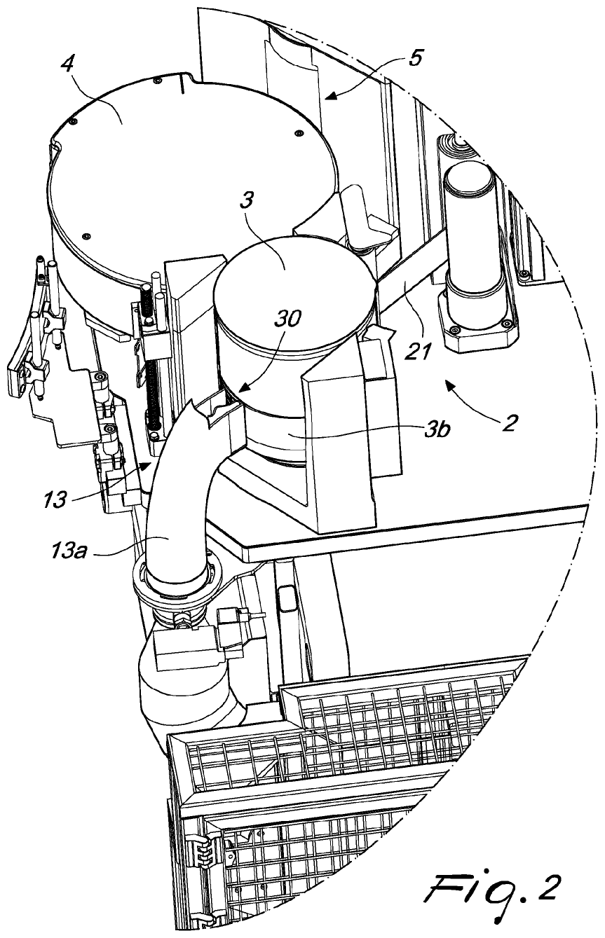

With reference to the embodiment shown in FIGS. 1 and 2, the cutting device comprises a cutting drum 3, which is arranged downstream of said unwinding assembly, while downstream of the cutting drum 3 there is the transfer device, which comprises a transfer drum 4 adapted to move the respective labels 22, separated after cutting, into contact with corresponding containers 10.

The transfer drum 4 faces the adhesive application device 5.

According to a preferred embodiment, the removal means 13 are arranged at the cutting drum 3 in order to remove at least one label 22b from the flow of labels 22 fed to the transfer drum 4.

Conveniently, the cutting drum 3 is associated with a device 3a for cutting the labeling ribbon 21 and with a device 6 for transferring the cut labels 22 toward the transfer drum 4.

In particular, the removal means 13 are arranged at a removal region 30 which is arranged at the cutting drum 3 between the cutting device 3a and the transfer device 6 along the advancement direction of the flow of labels 22.

Advantageously, the cutting drum 3 has a lateral surface 3b which has a plurality of holes connected to means for forced air extraction, so that the labels 22 are kept in adhesion against said lateral surface 3b.

According to a preferred embodiment, the removal means 13 comprise means for interrupting the effect of the extraction means at a portion of the lateral surface 3b of the cutting drum 3 which faces the removal region 30.

According to another possible embodiment, the cutting device and the transfer means are formed at a cutting and transfer drum.

In this case, the cutting drum 3 has a lateral surface provided with a plurality of holes connected to means for forced air extraction, so that the labels 22, which are cut on the same drum, are kept in adhesion against the lateral surface.

In this case, the removal means 13 comprise means for interrupting the effect of the extraction means at a portion of the lateral surface of the cutting and transfer drum that faces the removal region 30.

Conveniently, the removal means 13 further comprise blower means which are adapted to generate on command a flow of air which passes through the holes of the lateral surface 3b from the inside of the cutting drum 3 toward the outside of the cutting drum 3 at the portion of the lateral surface 3b of the cutting drum 3 that faces the removal region 30 so as to facilitate the removal of the labels 22 from the flow of the labels.

If the labeling machine has a single cutting and transfer drum, the removal means 13 further comprise blower means adapted to generate on command a flow of air which passes through the holes of the lateral surface from the inside of the cutting and transfer drum toward the outside of the cutting and transfer drum at the portion of the lateral surface of the cutting and transfer drum that faces the removal region 30, so as to facilitate the removal of the labels 22 from the flow of the labels.

Conveniently, the removal means 13 further comprise an extractor 13a provided with a suction inlet which is arranged so as to face the removal region 30.

The transfer drum 4 comprises a plurality of adhesive bonding portions, which are arranged so as to be angularly spaced around the axis 100 of the transfer drum 4 and are designed to receive by resting contact at least one longitudinal end 22a of the labels 22 in order to allow, in cooperation with the adhesive application device 5, the application of at least one respective strip of adhesive.

The labeling machine 1 comprises control and actuation means adapted to actuate the removal means 13.

The control and actuation means are functionally associated with a device for detecting the containers 10 to be labeled which are fed to the feeding assembly 10a.

Specifically, the device for detecting the containers 10, which is usually arranged along the feeding assembly 10a, detects any lack of one or more containers along the flow of containers.

The control and actuation means, once they have acquired this information, activate the removal means 13 so as to remove from the flow of labels 22 the label(s) 22b that would be designed to be applied on the missing containers.

The control and actuation means can be functionally associated. moreover, with a device for controlling the synchronization between the speeds of the containers to be labeled and the labeling ribbon 21 in order to discard the labels if a correct synchronization is not present.

The control and actuation means are furthermore configured to manage, during the transients adapted to bring the labeling machine 1 to the working condition, the cutting device 3a and, consequently, the removal means 13 in order to discard the labels of nonconforming length which therefore cannot be associated with a container.

According to a further aspect, the present disclosure relates to a method for labeling containers, comprising the steps of feeding, by means of an unwinding assembly, a labeling ribbon 21 to a cutting drum 3, cutting the labeling ribbon 21 at the cutting drum 3 in order to obtain a flow of labels 22, sending the flow of labels 22 to a transfer drum 4, applying, at the transfer drum 4, at least one adhesive to at least one portion 22a of the labels 22, and transferring the labels 22 to a corresponding container 10 to be labeled.

According to the disclosure, the method comprises a removal step, which can be activated on command and is adapted to remove at least one label 22b of the flow of labels 22 from the cutting drum 3.

In practice it has been found that the disclosure achieves the intended aim and advantages, providing a machine (and a method) for labeling containers which allows to discard labels without any adhesive being applied thereon.

The disclosure thus conceived is susceptible of numerous modifications and variations, all of which are within the scope of the appended claims; all the details may furthermore be replaced with other technically equivalent elements.

In practice, the materials used, so long as they are compatible with the specific use, as well as the contingent shapes and dimensions, may be any according to the requirements and the state of the art.

1-17. (canceled)

18. A machine for labeling containers, comprising an assembly for feeding containers to be labeled to a labeling assembly, said labeling assembly comprising an assembly for unwinding a labeling ribbon which comprises, along an extension thereof, a plurality of labels, a cutting device arranged downstream of said unwinding assembly and configured to cut said labeling ribbon at respective separation portions so as to obtain said labels, downstream of said cutting device there being transfer means adapted to move the respective labels separated after cutting into contact with corresponding containers at a transfer region, and further comprising removal means, which can be activated on command, for removing at least one label from a flow of labels, said removal means being arranged upstream of said transfer region.

19. The labeling machine according to claim 18, wherein said removal means are arranged upstream of said adhesive application device.

20. The labeling machine according to claim 18, wherein said transfer means face an adhesive application device which is configured to apply at least one adhesive to at least one portion of said labels prior to a transfer of said labels to the corresponding container.

21. The labeling machine according to claim 20, wherein said cutting device comprises a cutting drum arranged downstream of said unwinding assembly, downstream of said cutting drum there being said transfer device, which comprises a transfer drum adapted to move the respective labels separated after cutting into contact with corresponding containers, said transfer drum facing said adhesive application device.

22. The labeling machine according to claim 21, wherein said removal means are arranged at said cutting drum, in order to remove at least one label from the flow of labels fed to the transfer drum.

23. The labeling machine according to claim 21, wherein said cutting drum is associated with a device for cutting said labeling ribbon, and with a device for the transfer of the cut labels to said transfer drum, said removal means being arranged at a removal region which is arranged at said cutting drum between said cutting device and said transfer device along the advancement direction of the flow of labels.

24. The labeling machine according to claim 23, wherein said cutting drum has a lateral surface which has a plurality of holes connected to means for forced air extraction, so that the labels are kept in adhesion against said lateral surface, said removal means comprising means for interrupting the effect of said extraction means at a portion of said lateral surface of said cutting drum which faces said removal region.

25. The labeling machine according to claim 23, wherein said cutting device and said transfer means are formed at a cutting and transfer drum, said cutting and transfer drum having a lateral surface which is provided with a plurality of holes connected to means for forced air extraction so that the labels are kept in adhesion against said lateral surface, said removal means comprising means for interrupting the effect of said extraction means at a portion of said lateral surface of said cutting and transfer drum which faces said removal region.

26. The labeling machine according to claim 24, wherein said removal means comprise blower means which are adapted to generate on command a flow of air which passes through said holes of said lateral surface from the inside of said cutting drum toward the outside of said cutting drum at said portion of said lateral surface of said cutting drum that faces said removal region in order to facilitate the removal of said labels from the flow of the labels.

27. The labeling machine according to claim 25, wherein said removal means comprise blower means which are adapted to generate on command a flow of air which passes through said holes of said lateral surface from the inside of said cutting and transfer drum toward the outside of said cutting and transfer drum at said portion of said lateral surface of said cutting and transfer drum that faces said removal region in order to facilitate the removal of said labels from the flow of the labels.

28. The labeling machine according to claim 23, wherein said removal means comprise an extractor provided with a suction inlet which is arranged so as to face said removal region.

29. The labeling machine according to claim 18, wherein said transfer drum comprises a plurality of adhesive bonding portions, which are arranged so as to be angularly spaced around an axis of said transfer drum and are designed to receive by resting contact at least one longitudinal end of said labels in order to allow, in cooperation with said application device, the application of at least one respective strip of adhesive.

30. The labeling machine according to claim 18, further comprising control and actuation means adapted to actuate said removal means.

31. The labeling machine according to claim 30, wherein said control and actuation means are functionally associated with a device for detecting the containers to be labeled which are fed to said feeding assembly.

32. The labeling machine according to claim 30, wherein said control and actuation means are functionally associated with a device for controlling a synchronization between speeds of said containers to be labeled and of said labeling ribbon.

33. The labeling machine according to claim 30, wherein said control and actuation means are configured to manage, during transients adapted to bring said labeling machine to a working condition, said cutting device and said removal means in order to reject labels of nonconforming length which therefore cannot be associated with a container.

34. A method for labeling containers, comprising the steps of feeding, by means of an unwinding assembly, a labeling ribbon to a cutting device, cutting said labeling ribbon at said cutting device in order to obtain a flow of labels, sending said flow of labels to transfer means, applying and transferring said labels to a corresponding container to be labeled, and further comprising a removal step, which can be activated on command and is adapted to remove at least one label of nonconforming length from the flow of labels upstream of a transfer region for the transfer of said labels to said containers.
